(19) United States
(12) Patent Application Publication
(10) Pub. No.: US 2009/0227426 A1
(43) Pub. Date: Sep. 10, 2009

(54) Activity board

(76) Inventor: Graeme Andrew Dubar, Kaiapoi (NZ)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/583,416

(22) PCT Filed: May 26, 2006
(86) PCT No.: PCT/NZ06/00133

§ 371 Date: May 11, 2009

(51) Int. Cl. A63B 69/00; G09B 9/02; A63B 22/16

(52) U.S. Cl. 482/34; 482/146; 482/51

(57) ABSTRACT

An activity board assembly (1) including; a board (2) having an upper surface (3) for supporting a user (46), a base portion (4) and a resilient support member (5) having an upper and a lower distal end, said upper end being connected to an underside of the board and the lower distal end being connected to the base portion (4), characterised in that the board (2) is rotatable with respect to the base portion (4) about; a first axis in a plane substantially orthogonal with the upper surface (3) of the board and/or the base portion (4); a second axis substantially orthogonal to the first axis and substantially parallel to the upper surface (3) of the board and/or the base portion (4); a third axis orthogonal to both the first and second axis; the connection between the resilient support member (5) and the base portion (4) being configured to prevent linear movement with respect to each other.

### TECHNICAL FIELD

The present invention relates to an activity board, in particular an activity board for the simulation of board sports such as skateboarding, snowboarding, surfing and the like.

### BACKGROUND ART

Board sports such as surfing, skateboarding and snowboarding have enjoy widespread popularity, with a cross-over appeal to users by virtue of comparable body movements employed in the different disciplines.

However, a drawback of each of these board disciplines is their inherent dependency on particular environmental conditions (i.e. snow, surf, and the like) which may not be readily accessible to users at any given time. Consequently, the desire to practice such sports in any environment has led to a number of simulator devices. Physical board sports simulators have also been interfaced with computing means to represent the movement of the board on a visual display.

Prior art in this field includes the device disclosed in U.S. Pat. No. 4,966,364 comprising a snowboard-shaped board rotatably mounted on a biasing cushion with a cushioned spring attached to either longitudinal end of the board. Thus the user may tilt the board in any direction while bouncing either end off the surface if they so hit. While this device simulates the general actions of a board it does not simulate the dynamics of board sports effectively as the cushion offers only limited resistance.

A surfboard simulating device is described in the U.S. Pat. No. 5,509,871 by Giovanni. This device comprises a surfboard placed on top of a spring assembly on top of a supporting base. While this offers a more dynamic response due to the spring assembly it does not allow the user to rotate the board about a vertical axis.

One device that does offer a high dynamic response and 360 degree rotation about a vertical axis is described in the U.S. patent application Ser. No. 10/195,927 by Sachs. This device has a central support pole attached to a support frame via a spring cradle. A board is coupled to the top of the support pole by a biasing spring attached coaxially around a universal joint. Whilst permitting a movement of the board in a range of motions, the device is complex and cumbersome.

A smaller and more compact board sports simulator is described by Guidry in U.S. Pat. No. 5,730,690. However, the board offers a limited range of motion and primarily provides an aid to the performance of skateboard tricks and does not replicate the movements of other board sports such as snowboarding.

Further known board sports simulators provide a representation of the physical movements of the board onto a visual display screen. U.S. Pat. No. 4,817,950 (Goo) describes a board located above a supporting structure biased to return the board to a horizontal position. A plurality of electric contacts are engaged by a pendulum or ball bearing that moves in response to board movements, generating corresponding movement signals. A computer or processing device receiving the movement signals generates a visual representation of the movement on a visual display. However, the simulator is configured to replicate surfing and provides little adaptability to simulate the range of motions in other board sport such as snowboarding.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein; this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided an activity board assembly including;
a board having an upper surface for supporting a user,
a base portion and
a resilient support member having an upper and a lower distal end, said upper end being connected to an underside of said board and said lower distal end being connected to said base portion,
   characterised in that the board is rotatable with respect to the base portion about;
a first axis in a plane substantially orthogonal with the upper surface of the board and/or the base portion;
a second axis substantially orthogonal to said first axis and substantially parallel to the upper surface of the board and/or the base portion;
a third axis orthogonal to both the first and second axis; said connection between the resilient support member and the base portion being configured to prevent linear movement with respect to each other.

In a preferred embodiment, the board is rotatable about said first axis by a rotatable connection (e.g. a bearing, or a shaft and a rotating member rotatable about said shaft) between the resilient support member and either the board or the base portion.

The freedom of movement of the board thus replicates that provided by a snowboard, skateboard, surfboard or the like. The ability to turn the board about the first axis for example replicates spinning a board about its own length as may be undertaken for example by a snowboarder executing a 180° or 360° spin substantially in the horizontal plane.

According to a further aspect, the board has an elongated configuration with a major or longitudinal axis and a minor or lateral axis co-axial with said 2^{nd} and 3^{rd} axes respectively.

To aid clarity, the rotation of the board about the three axes is herein described with reference to the well established terms yaw, pitch and roll designating the relative orientation of rotational movements performed by a given craft or object.

Thus, according to a preferred embodiment, ‘yaw’, ‘roll’ and ‘pitch’ respectively designate rotation about said first, second and third axis. In embodiments with an elongated board configuration, pitch and roll are defined as rotation about the lateral and longitudinal axis respectively.

As the support member is resilient, but fixed at the lower end from non-rotational movement, the upper end attached to the board is moveable according to any dynamic input from a user positioned on the upper board surface. Any non-symmetrical weight distribution by the user over the board thus causes a bending of the resilient support member, displacing it away from its equilibrium upright position. This bending moment effectively provides a rotation about an arc approximately centred at the connection between the base portion and the lower end of the support member. This bending moment thus provides at least a component of rotational movement about the second or third axes, i.e. roll and/or pitch.

Thus, according to a preferred embodiment, lateral displacement of said upper end of the support member from said first axis provides at least a component of rotational movement about the second or third axes.

The resilient support member may be formed in a variety of materials and configurations including a coil spring, a unitary or laminate elastic rod, or any other object capable of bearing the weight of a user mounted on the board without permanent deformation whilst also being capable of resilient lateral displacement or bending at the upper end under the effects of eccentric forces applied by the user about the first axis. Thus, when the board assembly is placed on a level surface, the resilient support member not only supports the board and a user on the board, but is also biased towards returning the board to an equilibrium position with the said first axis vertically aligned. A resilient support member in the form of a spring also allows linear movement of the board along said first axis, to provide a form of ‘suspension’ effect.

As discussed above, the effect of roll may be provided by laterally displacing the upper end of the support member. However, board sports such as skate boarding, snowboarding, surfing and so forth share common ground in that the board is typically steered by tilting the board laterally about its longitudinal axis. In a snowboard, this tilting action brings a radiused side-cut configuration along the board's side into contact with the snow, causing the board to turn by circumscribing an arc of the same radius as the side-cut. A skateboard is turned by selectively applying greater user's weight to a single side of the board, tilting the board downwards on the weighted side and consequently rotating the forward and rearward skate trucks inwards and thus turning the board through an arc. To replicate this tilting feature and associated user steering technique, the present invention preferably provides a tilting mechanism interposed between the upper end of the flexible support means and the lower surface of the board. Said tilting mechanism thus provides rotation about the second, or longitudinal board axis, i.e. roll.

In one embodiment, the tilting mechanism is at least one unitary elastic block mounted along the longitudinal board axis. Alternatively the tilting means is a ball joint, wherein the ball attached to the resilient support means and the enclosure of the ball attached to the board or vice versa.

In other embodiments said tilting mechanism is a hinge, universal joint, articulated member, swivel, or other similar devices.

In further embodiments said tilting mechanism incorporates a biasing means (e.g. a spring, coil, elastic member, or the like) to bias the tilting means towards an equilibrium position with the board substantially level. The degree of permissible travel of the board about said second axis (i.e. roll) due to said tilting mechanism may be restricted by stops (preferably adjustable) equidistantly spaced about either side of the longitudinal board axis located on, or acting on the lower board surface. In a further embodiment, the stops are at least partially resilient, e.g. springs, elastic materials or the like.

Preferably the rate of yaw is user-adjustable. The rate of yaw may be controlled by varying the degree of friction involved in rotating the board. Thus the yaw rate may be adjusted to suit the user's needs. If the degree of rotational friction is high, the board will be more stable to a user, though less responsive. Reducing the friction provides a more dynamic response permitting advanced user activities or tricks.

In one embodiment the yaw rate of the board is adjustably limited by an at least one friction contact (e.g. a screw/bolt) extending from the rotating member about a shaft of said rotating connection, said screw being incident on said shaft or a bearing about said shaft.

In other embodiments the yaw rate is adjustably limited by a bracket about the shaft, the bracket capable of being adjustably tightened to restrict the yaw rate.

In a yet further embodiment, the present invention provides an activity board assembly substantially as hereinbefore described, further including at least one displacement assembly, located between said lower board surface and the resilient support member, said displacement assembly being configured to allow at least partially translational relative movement between the board and the resilient support member at least partially along, or parallel to the second and/or third axis.

In one embodiment, said translational movement is constrained solely within a plane extending through both the first and third axes, and preferably being constrained to movement substantially along the third axis.

The incorporation of at least one such displacement assembly provides the user with a yet further range of board motions. Embodiments where the allowable translational movements are constrained to act substantially laterally to the boards longitudinal axis (i.e. substantially along the minor, or third axis), simulate the side-slipping action present in some board sports, particularly snowboarding. Counteracting the unbalancing effect of such side-slipping board motions, (in addition to the other range of board motions described herein) provides yet further training and simulation benefits, together with an increased level of difficulty for the rider to master.

As referred to above, the displacement assembly(s) may also be configured to allow substantially translational board movement along the first/longitudinal axis. However, it will be readily appreciated by one skilled in the art that this does not replicate a key characteristic of the major known board sports and is thus a less preferred feature. Nevertheless, from a technical perspective, such a configuration is easily implemented and provides the user with further balancing challenges. To avoid undue complexity, the remainder of the specification will consider the use of lateral displacement assemblies only, though it will be understood the invention is not limited to same.

In a preferred embodiment, said translational movement is constrained along a path located substantially equidistantly either side of a central point positioned on said longitudinal second axis. In one embodiment, at least one displacement assembly is biased towards said central point by at a biasing means. It will be readily appreciated that several biasing means may be employed, such as springs, elastomeric materials, buffers, hydraulic or pneumatic drives and/or any other resilient mechanism or material. In one embodiment, the biasing means consists of a pair of compression springs orientated in a substantially opposed alignment within a track either side the second axis.

In one embodiment, said track is partially curved laterally upwards and outwards from the longitudinal board axis. This provides a further restorative force to bias the board back towards the centre position. The board may travel in said track or along any other convenient guiding or constraining fitting, mechanism or structure.

According to one aspect of the present invention there is provided an activity board assembly including;
a board having an upper surface for supporting a user, a base portion;
a resilient support member having an upper and a lower distal end, said upper end being connected to an underside of said board and said lower distal end being connected to said base portion, and
at least one displacement assembly, located between said lower board surface and the resilient support member,
   characterised in that the board is rotatable with respect to the base portion about;
a first axis in a plane substantially orthogonal with the upper surface of the board and/or the base portion;
a second axis substantially orthogonal to said first axis and substantially parallel to the upper surface of the board and/or the base portion;
a third axis orthogonal to both the first and second axis;
   said displacement assembly being configured to allow at least partially translational relative movement between the board and the resilient support member at least partially along, or parallel to the second and/or third axis.

In one embodiment, said translational movement is constrained solely within a plane extending through both the first and third axes, and preferably being constrained to movement substantially along the third axis.

According to another aspect of the present invention there is provided a base portion for an activity board assembly as herein described; said base portion having a laterally-enlarged ground-engaging lower surface and a central connecting member connected to the lower end of the resilient support member. The laterally enlarged lower surface provides a stable platform to permit the board to undergo vigorous user-motions without instability. It will be readily apparent that numerous configurations are possible, including one-piece ground engaging structures or plates or alternatively a plurality of detachable or retractable legs or the like extendable from the central connecting member.

Thus, according to one embodiment, said base portion includes a ground engaging lower surface laterally enlarged with respect to the support member extending orthogonally therefrom. In an alternative embodiment, the base portion includes a plurality of detachable, or retractable stabilizing legs, extending radially outwards from said central connecting member.

Thus the base portion supports the user and activity board assembly throughout the full range of motions the user is able to achieve, even when the center of mass of the user and activity board assembly is off-center and/or the resilient biasing member is not at equilibrium.

In preferred embodiments said plurality of stabilizing legs extend radially outwards from said central connecting member for a length equal to or greater than the length of the resilient biasing member in said first axis.

In a further embodiment of the present invention, said base portion is a panel, disk or other surface of sufficient area to support said activity board assembly and the user.

Whilst the above-described embodiment provides a realistic simulation of the user motions involved in many board sports (and the ability to undertake the activity in a domestic location if desired), it lacks the sensation of speed and travel associated with the original board sport. This may be expediently addressed by the addition of wheels or rollers to the activity board assembly. The mobility offered by such a modification provides a significant alternative dimension to the activities, movements and sensations available to the user. Moreover, such a feature may be readily included as an optional extra, or integrated into the assembly as a permanent capability.

Thus, according to a further aspect of the present invention, there is provided an activity board assembly substantially as hereinbefore described, said activity board assembly further incorporating at least one wheel or roller assembly located on said base portion ground-engaging lower surface. According to one embodiment, said wheels/rollers are detachable from the base portion. In an alternative embodiment, said wheels/rollers are integrally formed with the base portion.

In additional embodiments said wheels/rollers are adjustably connected to the base portion between an engaged position, wherein the wheels are in direct contact with the ground surface, and a disengaged position, wherein the base portion is in direct contact with the ground surface, such that when in an engaged position, the wheels support the activity board assembly.

Thus the user may choose whether to be able to move across the work surface or not, simply by changing the wheels between an engaged position and a disengaged position.

According to a further aspect of the present invention there is provided an activity board assembly including;
a board having an upper surface for supporting a user,
a base portion and
a support member having an upper and a lower distal end, said upper end being connected to an underside of said board and said lower distal end being connected to said base portion,
   characterised in that the board is rotatable with respect to the base portion about;
a first axis in a plane substantially orthogonal with the upper surface of the board and/or the base portion;
a second axis substantially orthogonal to said first axis and substantially parallel to the upper surface of the board and/or the base portion;
a third axis orthogonal to both the first and second axis;
   said base portion being provided with one or more wheel or roller assemblies on a lower surface.

It will be appreciated that a variety of terrain may be traversed according to the type and size of wheel/roller assemblies fitted. Whilst small castors or the like may be utilised on smooth, hard surfaces, larger wheels providing sufficient ground clearance and robustness may be utilised for rough terrain. In one embodiment, the base portion may be formed with a plurality of leg portions disposed radially outwards from a central portion connected to the support member. Preferably, said wheel or roller assemblies are position towards the distal end of said legs. In one embodiment, said legs are retractable (e.g. telescopic) and/or detachable. In a further embodiment, said wheels and/or roller assemblies are pivotally attached to said base portion, such that the wheel and/or roller assembly is movable between a ground contacting position and a non ground contacting position. Thus, the activity board may be utilised in either a static configuration with the wheels positioned away from the ground or in a mobile configuration with the wheels supporting the activity board from lateral movement across the ground.

According to another aspect of the present invention there is provided an activity board assembly substantially as hereinbefore described, said activity board assembly being adapted for constrained movement along a guiding track.

According to another aspect of the present invention there is provided an activity board system including one or more activity board assemblies substantially as hereinbefore described, said activity board assemblies being adapted for constrained movement along a guiding track.

As will be well understood by one skilled in the art, the activity board assembly may be adapted in numerous ways to engage with, integrate, align or otherwise interact with a guiding track for constrained movement along a track without departing from the scope of the invention.

According to a further aspect of the present invention there is provided an activity board assembly including;
a board having an upper surface for supporting a user,
a base portion, and
a support member having an upper and a lower distal ends, said upper end being connected to an underside of said board and said lower distal end being connected to said base portion,
   characterised in that the board is rotatable with respect to the base portion about;
a first axis in a plane substantially orthogonal with the upper surface of the board and/or the base portion;
a second axis substantially orthogonal to said first axis and substantially parallel to the upper surface of the board and/or the base portion;
a third axis orthogonal to both the first and second axis;
   said base portion being adapted for constrained movement along an elongate guiding track.

According to one embodiment; said base portion includes a plurality of rolling members interposed between the base portion and the guiding track. In one embodiment, the elongate track is configured as a continuous extrusion with an ‘I’, or ‘T’ shaped cross-section. Preferably, said lower surface of the base portion being configured to interface or at least partially surround at least the upper portion of said track.

In one embodiment the guiding track is orientated with an at least partially inclined path. A user may thus initially propel the board by skating with one foot pushing on the adjacent ground surface until the effects of gravity maintain or increase the board's speed. The track may be undulating and/or curved to provide entertainment and challenge for the user. Such purpose-designed tracks may be featured in recreational, theme or skate parks, or the like. As the activity board assembly travels along the track, the user is confronted with the challenge of balancing on the board during its journey.

In further embodiments there is provided a brake mechanism for controlling the speed of the activity board assembly along said elongated track.

As the board is raised above contact with the ground, the user can not use conventional means of speed control employed in snowboarding, skate boarding or the like. In most board sports the user can control the speed by turning and pushing the underside of the board against the terrain surface. Thus, the brake mechanism provides the user with a means to control the board speed to prevent loss of control and/or the user becoming detached from the board. In one embodiment, the brake is hand-operated and acts to apply a frictional clamping action on said track. Alternatively, the brake may be configured to act on one or more rolling members supporting the activity board assembly on the track. It will be readily apparent to one skilled on the art that numerous alternative configurations are possible.

According to further embodiments, the present invention includes at least two attachment members adapted to prevent the base portion from detaching from the guiding track. Preferably, said attachment members are rolling members attached to the base portion and in communication with a guiding channel on the guiding track.

According to a further aspect of the present invention there is provided an activity board assembly adapted to interface with a processor and display.

According to a further aspect of the present invention there is provided an activity board system as hereinbefore described including a processor configured to be interfaced with a display.

According to one aspect, the activity board further includes a sensor system capable of detecting the position and/or movement of the board and transmitting same to said processor and display.

In one embodiment, the position and/or movement of the board is detected with respect to the base portion and/or the support member. Alternatively, the position and/or movement of the board can be detected with respect to a reference point positioned external to the activity board.

The orientation and movement of the board may be determined by sensors providing continuous feedback on the instantaneous position of the board, or at least specific points on the board. The relative position of, for example, points at the extremities of said major and minor board axes may be continuously or intermittently detected and represented as co-ordinates according to their spatial position with respect to said first, second and third axes.

Alternatively, provided the initial position orientation of the board is known, the subsequent orientation may be calculated from sensors providing feedback on the rate of movement about the first, second and third axis. In a further embodiment, a combination of location sensors and movement sensors may also be employed. The feedback from the sensors is input into said processor and thereafter output to said display as a graphical representation of the board's position and movement. Movement of the board may interact with a depiction of a continuous virtual terrain environment represented on the display, e.g. a snowboard racecourse.

A wide range of location and movement sensors may be employed, according to performance, manufacturing and cost criteria. Location sensors include, but are not limited to, mechanical, electrical, magnetic, ultrasonic, capacitive, optical, contact, rolling or proximity sensors or the like. Preferably, said location sensors are positioned about the rotatable connection between the board and the support member to detect yaw and optionally (dependant on the capabilities and placement of the sensors) pitch stemming from movement of said tilting mechanism.

However, such sensor configuration would not provide feedback on the board movement about said third axis. As this movement is caused by bending of the upper end of the resilient support member away from the first/vertical axis, there is little practical application for contact sensors to determine movement/location. However, certain simplified interactive software may operate without data on rotation about the third axis and thus omit the requirement for additional or alternative sensors.

If the specific orientation of the board in three dimensions is required, a number of non contact sensing technologies may be employed including;
1. emitter and detector sensors positioned in complimentary configurations on the underside of the board and the base portion, wherein each detector is capable of determining the relative distance to a corresponding emitter. The emitter/detectors may utilize infra-red, ultrasonic, radio, optical, microwave or any other suitable acoustic or electromagnetic emissions.
2. proximity sensors located in either the board or the base portion operating on a capacitive, inductive, magnetic principles sensing the proximity between the board and base portion. Placement of predetermined portions of material having a uniquely identifiable signature in the lateral and longitudinal extremities of the board enables said processor to calculate the orientation of the board from the different detected signal strengths from detectors located in distinct locations in the base portion.
3. spatial orientation sensors positioned in the board such as gyroscopic, inertial, tilt sensors and the like independently measure the effects of any linear or rotational movement of the board.
4. active sensors such as ultrasonic emitters and detector sensors located together on the underside of the board, whereby emissions from the emitter are reflected from the ground and/or base portion and reflected back to the detector sensor. The distance of the emitters from the ground (and therefore the orientation of the board) can thus be calculated. Preferably, such a sensor configuration is used in conjunction with a rotation sensor to remove ambiguity in the yaw measurement.
5. emitters and detectors sensors positioned in complimentary configurations wherein a plurality of transmitters are located on the board at predetermined locations, (e.g. endpoints of the major and minor axes) and at least one receiver positioned externally from the board. The receiver measures the difference in time between a reference emitter at a fixed position (e.g. on supporting base portion) and the other emitter, each having a unique identifying signal. The emitted signals may be infra-red, ultrasonic, radio, optical, microwave or similar emissions.

The processor may take the form of a games console, personal computer, or any other convenient computational and processing means. The activity board or the processor may also incorporate one or more transducers to convert the signal output by the sensors into an electrical signal conditioned for use by the processor. In yet further embodiments the movement of the user may also be detected and transmitted to the processor to generate a corresponding image of the user's movement on the display.

The user's movements may be sensed either by the incorporation of known opto-electrical sensors such as the SONY® EYE TOYT™ capable of detecting human movement and generating a corresponding interactive display image. In an alternative embodiment, one or more sensors or detectable patches may be applied or worn by the user and operate in a corresponding manner to the board location and movement sensors described above to determine the position of the users limb, torso, or head to which the sensor/patch is applied.

In addition to adding to the realism of the user's activities depicted in the display, recording the user's body movement also provides a potential training tool to coach the user in the optimal stance and body movements during predetermined action.

Aspects of the present invention have been described by way of example only and it should be appreciated that modifications and additions may be made thereto without departing from the scope thereof.

### BRIEF DESCRIPTION OF THE DRAWINGS

FIG. 1a. Shows a side perspective view of an activity board assembly in accordance with a preferred embodiment, showing the roll and yaw of the board;

FIG. 1b) Shows a side perspective view of an activity board assembly in accordance with a preferred embodiment, showing the pitch of the board;

FIG. 2a. Shows a side perspective view of an activity board assembly in accordance with a further preferred embodiment provided with displacement assemblies;

FIG. 2b) Shows a further side perspective view of an activity board assembly shown in FIG. 2a), showing the pitch of the board;

FIG. 2c) Shows an enlarged perspective view of a displacement assembly shown in the embodiments shown in FIG. 2a-b);

FIG. 3a-c) Shows an activity board assembly with a screw thread adjustable yaw rate control;

FIG. 4 Shows an activity board assembly with a hinged jaw adjustable yaw rate control;

FIG. 5 Shows an activity board assembly adapted to ride a guiding track;

FIG. 6 Shows a braking mechanism for an activity board assembly adapted to ride a guiding track, and

FIG. 7 Shows a support base for an activity board assembly adapted for attachment to a work surface.

FIG. 8 Shows a schematic system diagram of a further embodiment incorporating an activity board interfaced with a processor and a display screen.

### BEST MODES FOR CARRYING OUT THE INVENTION

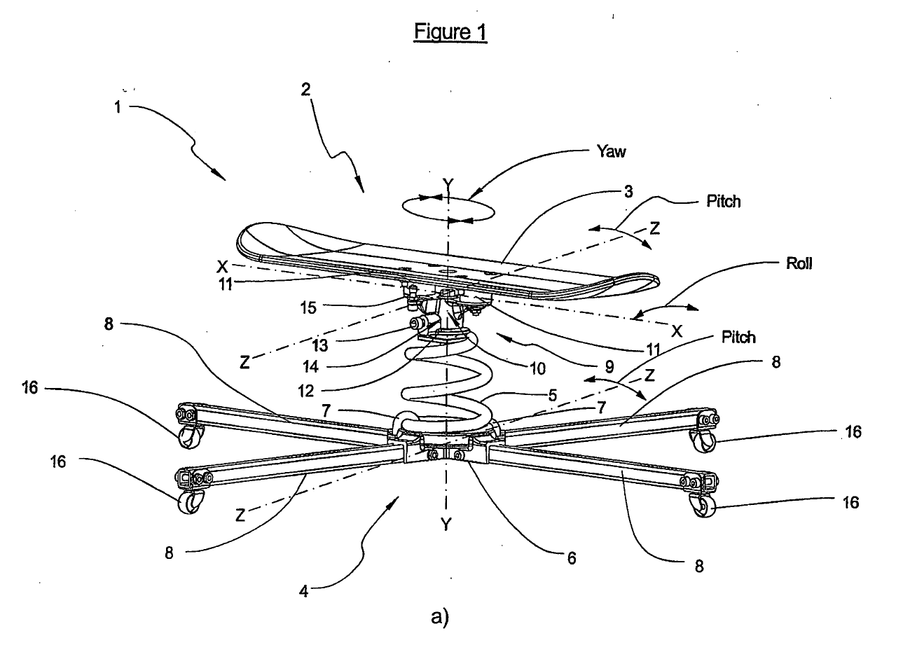

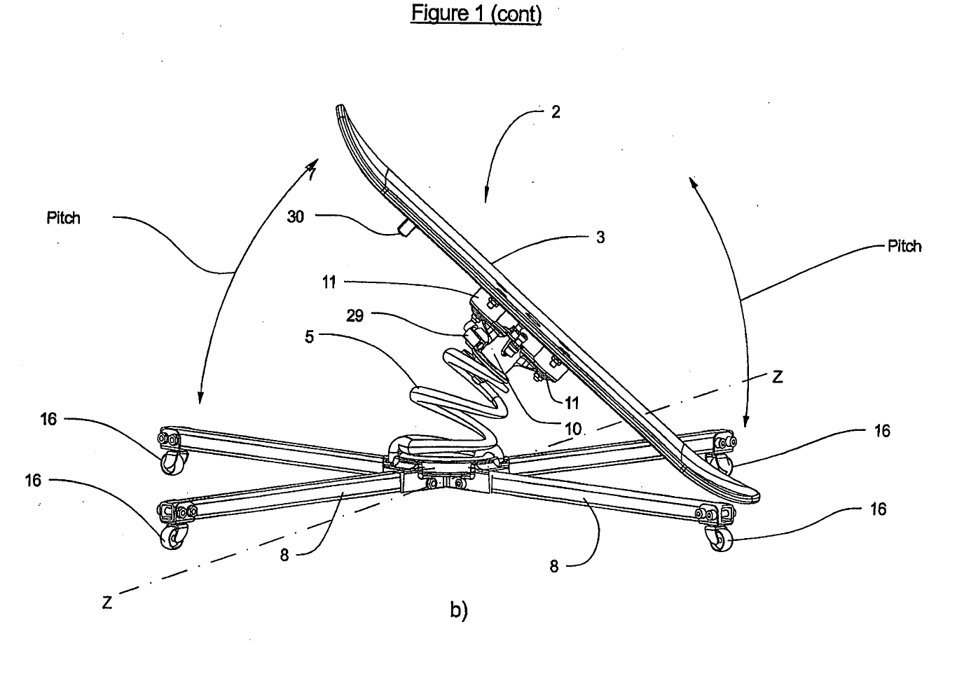

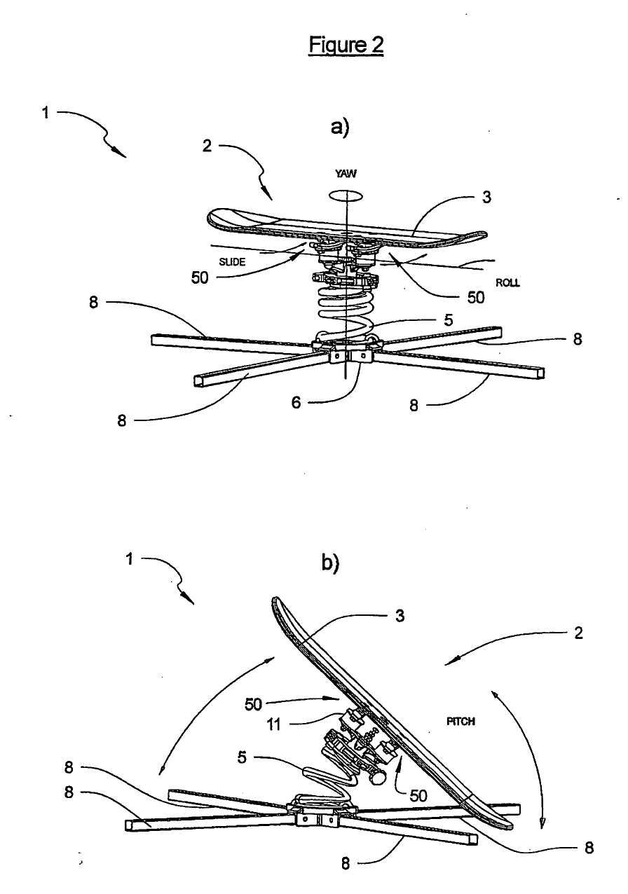

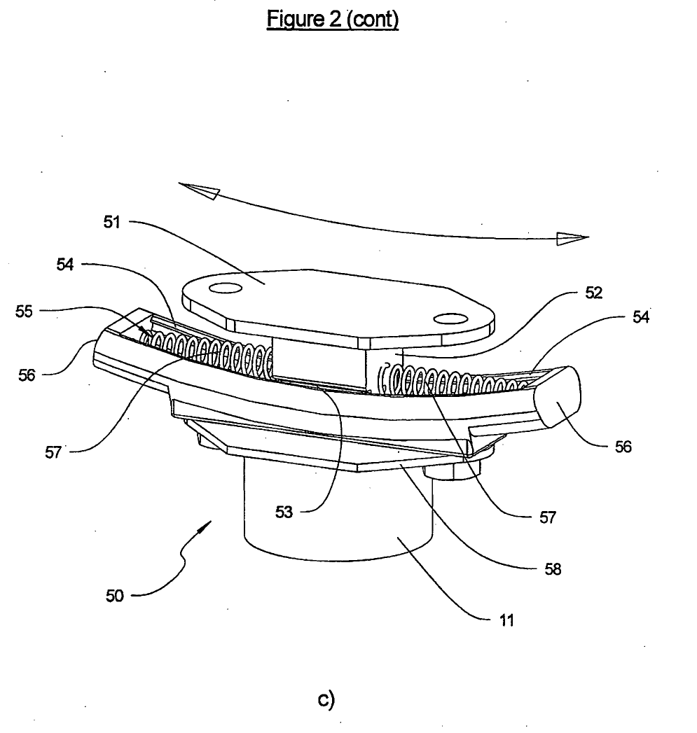

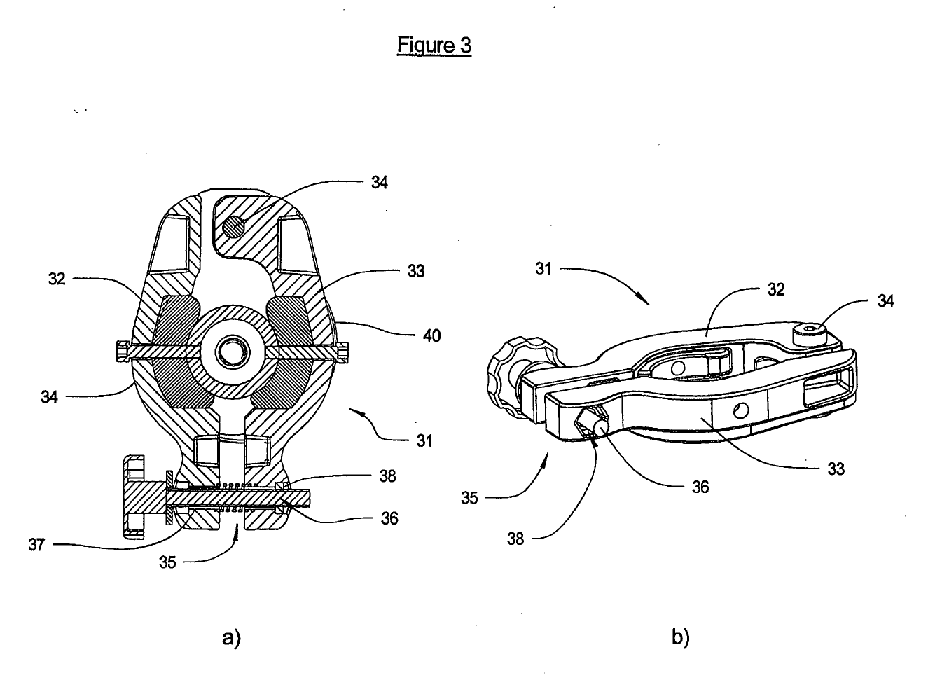

The present invention provides an activity board assembly and system as described herein with respect to the preferred embodiments shown in FIGS. 1-8. The activity board assembly (1) as shown FIGS. 1 to 3 includes a board (2) with an upper surface (3) capable of supporting a user (not shown). Typically, the upper surface (3) is covered in a high friction material to aid in the user's stability during the performance of maneuvers. In FIGS. 1 and 2, the board (2) is substantially configured to replicate a skateboard deck and is substantially elongated with rounded tips providing the board with a major, longitudal axis “X” and an orthogonal minor, lateral axis “Z”. The activity board assembly (1) also includes a base portion (4) and a resilient support member in the form of a coil spring (5) orientated with its axis of revolution aligned vertically upwards about axis “Y”.

The base portion (4) is comprised of a central housing (6) with a planar circular upper section adapted to receive the coil spring (5) and be secured thereto by u-shaped bolts (7). The base portion (4) further includes four leg portions (8) equidistantly disposed about the base portion (4) and extending outwardly in a substantially horizontal plane.

The board is attached to the spring (5) via a tilting mechanism (9) in the form of a housing (10) bolted to the underside of the board (2) via two unitary elastic blocks (11) aligned about the “X” axis.

The underside of the housing (10) includes a rotatable coupling (12) allowing the board (2) and tilting mechanism (9) to rotate about the “Y” axis. Thus, by virtue of the combined rotational capabilities of the coil spring (5), tilting mechanism (9), and rotatable coupling (12), the board may be rotated about the “Y”, “X” and “Z” axis, (or 1^{st}, 2^{nd} and 3^{rd} axes respectively).

FIG. 2 a-c) shows a further embodiment wherein the activity board assembly (1) further includes displacement assemblies (50), located between the lower surface of the board (2) and the coil spring (5). The embodiment shown in FIGS. 2a-b) show two displacement assemblies (50) located in substantially the same location as the two unitary elastic blocks (11) in FIGS. 1a-b). The displacement assembly (50) (shown more clearly in FIG. 2c)) is comprised of an upper mounting plate (51) attached at an upper surface to the underside of the board (2), with a guide cuboid block (52) extending from the lower plate (51) surface.

The guide block (52) is provided with grooves (53) on opposed lateral sides of the block (52) which co-operate with corresponding ridges along the upper peripheral edges (54) of a rectangular track (55). The track (55) is bounded at both distal ends by end wall portions (56) with a pair of opposed tension springs (57) located on either side of the guide block (52) and a respective end wall (56). The guide block and attached board (2), is thus constrained to move along the track (55) between the end walls (56), while the restorative effects of the springs (57) bias the guide block (52) and attached board (2) into an equilibrium centre position along the track (55). In preferred embodiments, this centre position is positioned along the longitudinal (X) axis of the board with the track (55) laterally orientated orthogonally to the X-axis. In the embodiment shown in FIGS. 2a-c) the track (55) is linear laterally to the x-axis, while in the z-axis, it equibits a slight upwards curve symmetrically either side of the longitudinal (x) axis. Thus, increased lateral displacement of the user and board (2) either side of the equilibrium centre position (i.e. the longitudinal x axis) also acts against an increased gravitational effect as the guide block (52) is forced upwards by the curved peripheral edges (54) of the track (55). The lower portion of the track (55) is fitted to a flange fitting (58) on the upper surface of a unitary elastomeric block (11) (as described in the preceding embodiment), which is in turn fitted to the coil spring (5) and base (6).

The displacement assemblies (50) provide the user with a yet further range of board motions. Embodiments such as that shown in FIG. 2 a-c), where the allowable translational movements are constrained to act substantially laterally to the boards longitudinal axis, simulates the side-slipping action of a board, particularly snowboarding. Counteracting the unbalancing effect of such side-slipping board motions, (in addition to the other range of board motions described herein) provides yet further training and simulation benefits, together with an increased level of difficulty for the rider to master. The degree of movement generated by the user along the track (55) for a given degree of user input may be varied by adjusting the strength of the springs (57) adjusting the degree of upward curvature of the track (55) and/or by adjusting the position of the end walls (56) inside the track (55) (e.g. by a threaded bolts passing through the end walls (56) and bearings on the springs (57).

It will be appreciated that alternative displacement assembly(s) (50) may also be utilised, configured to allow substantially translational board movement along the first/longitudinal axis. Moreover, it will be understood by one skilled in the art that the configuration of a displacement assembly may take numerous forms and is not limited to that described herein.

FIGS. 1, 2, and 3 show a braking mechanism fitted to the non-rotating portion of the rotatable coupling attached to the spring (5) and consists of a threaded bolt (13) passing through a small protrusion to bear on a portion of the rotatable housing (14). Adjustment of the bolt (13) provides mean of adjusting the freedom of movement of the board (2) about the “Y” axis.

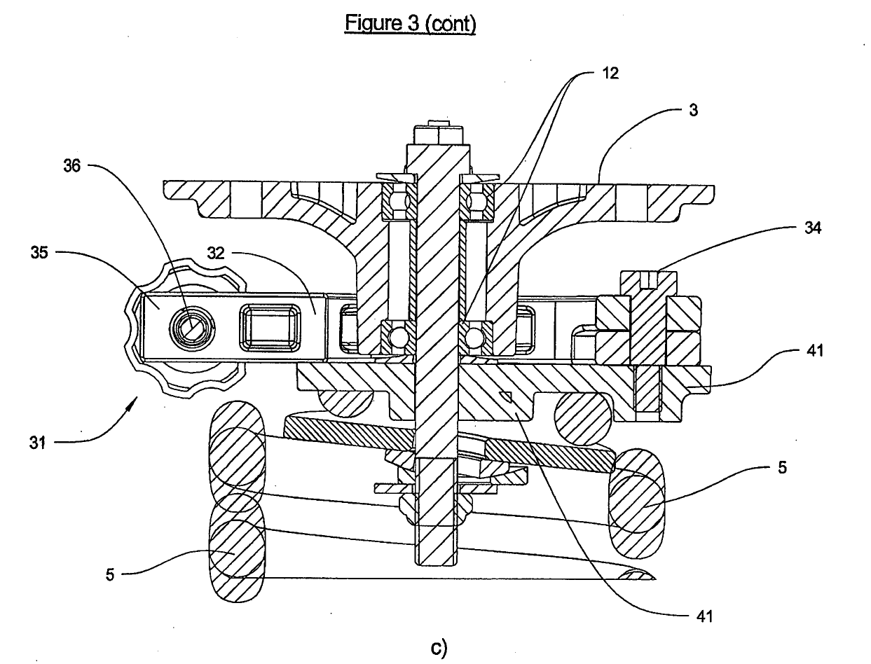

FIGS. 3a-c show an alternative braking mechanism (31) consisting of a pair of jaws (32, 33) mutually pivotally attached together at one end by a hinge (34). The jaws (32, 33) are releasably secured together at their non-hinged end (35) by an adjustable threaded bolt (36) passing through an aperture (37) in one jaw (32) to engage a complementary threaded aperture (38) in the opposing jaw (33). The centre portion (39, 40) of both jaws (33, 34) are partially outwardly curved away from each other to accept the substantially circular cross section rotatable coupling (12) shaft interposed between the jaws (33, 34). The jaws (33, 34) may thus be adjustably tightened (via adjustment of the bolt (36)) to vary the friction on the rotatable coupling to adjust the yaw rate, i.e., the ease with which the rider can produce rotation about the Y axis. The braking mechanism (31) is secured and maintained stationary to the upper end of the coil spring (5) via a corresponding fitting (41).

The permissible movement of the board (2) about the longitudinal “X” axis via the unitary block (11) may be limited by adjustable stops (15) attached to the housing (10) and positioned equidistantly about the either side of the longitudinal axis at the centre point of the board. The stops (15) may be adjusted for vertical travel, thereby adjusting the degree of permissible rotation by the board about the “X” axis until contacting the stop (15). In an alternative embodiment (not shown) the stops (15) may be formed as resilient members to bias the board (2) to return to a substantially horizontal position.

Rotational movement about the “Y”, “X” and “Z” axis, (also referred to as 1^{st}, 2^{nd} and 3^{rd} axes reflectively) may also be denoted by the terms yaw, roll and pitch.

It will be appreciated that movement of the spring (5) due to uneven weight distribution by the user on the upper surface of the board (3) causes the entire board (2) and tilting mechanism (9) to tilt in an arc substantially centred about the attachment point of the spring (5) to the central housing (6) of the base portion. Thus, the tilting or rotation about the “X” axis in a vertical plane passing through the longitudinal axis (as show in FIG. 2) of the board provides the effect of pitch. However, the same type of bending action of the spring (5) in an orthogonal direction (i.e. in a plane passing through the “Z” axis) also simulates the effect of roll.

FIGS. 1-3 show an embodiment provided with wheel assemblies (16).

In the embodiment shown, the wheel assemblies (16) are bolted to the legs (8) although they may be optionally configured to be pivoted in to and out of position for engagement with the ground. Alternatively, the wheel assemblies (16) may be permanently attached to legs (8) which in turn are detachably connected to the central base portion housing (6).

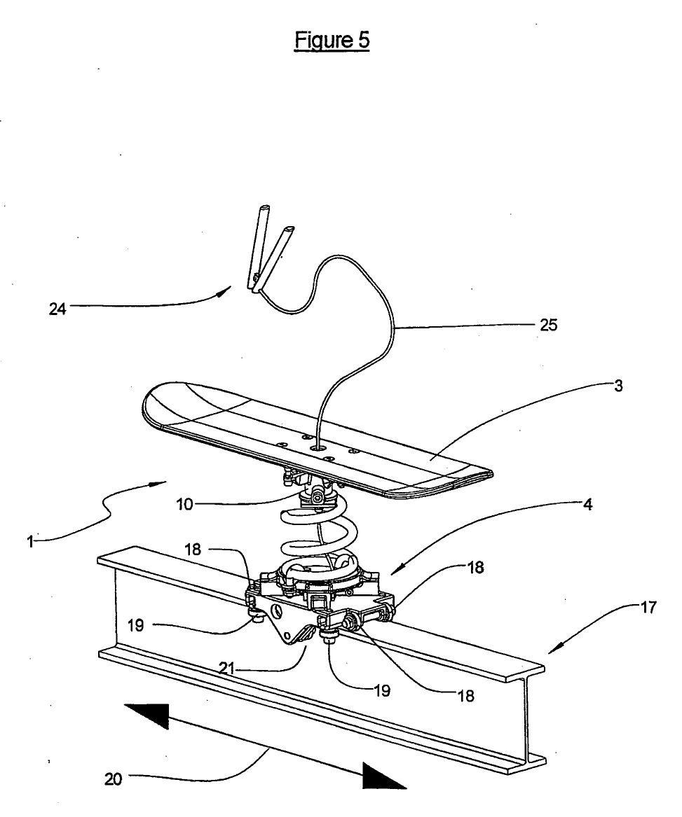

FIG. 5 shows a further embodiment of the present invention wherein in the activity board assembly (1) is adapted for constrained movement along a guiding track (17). In the embodiment shown in FIG. 5, the guiding track is configured as an “I” beam girder though it will be appreciated numerous alternative embodiments may be utilised. The base portion (4) is adapted to interact with the track (17) by provision of rolling members (18) positioned on the lower side of the base portion (4) to support the activity board (1) in free rolling contact with the guide track (17). Further lateral rolling assemblies (19) are provided on underside peripheral portions of the base (4) to interact with the sides of the I-Beam track. Thus, the lateral rolling assemblies (19) prevent lateral movement of the base portion (4) perpendicular to the longitudinal axis of the track (20). Further securing rolling assemblies (21) are located on flange portions (22) extending downwardly from the lateral side of the base portion (4) and positioned to engage with the underside surface of the upper horizontal planar surface of the I-Beam track (17) thus preventing the board assembly (1) becoming detached/dislodged from the track (17).

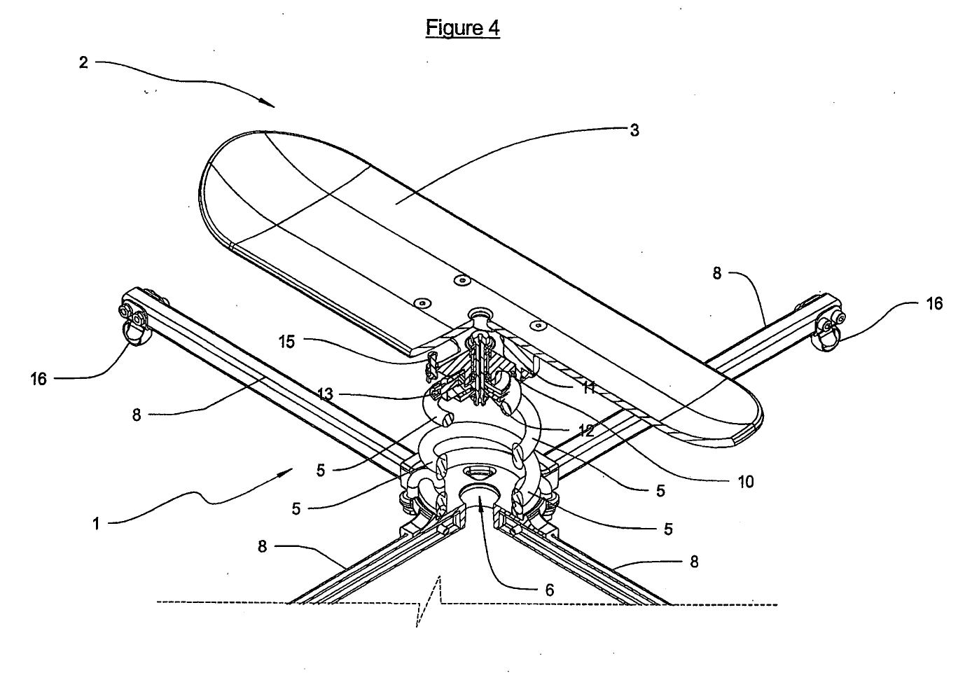

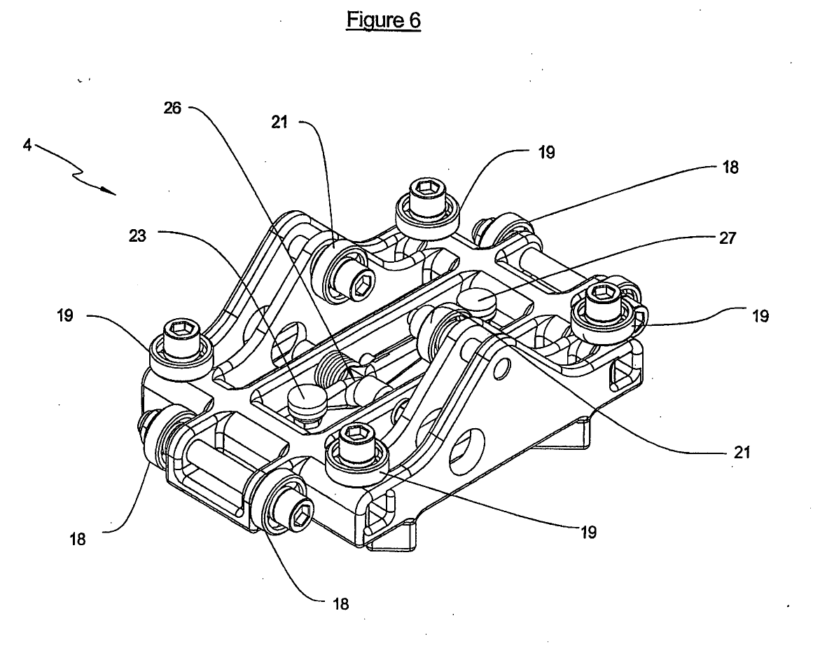

FIG. 6 shows a clearer illustration of the underside of the base portion (4) illustrated in FIG. 4 and also shows primary brake pads (23) used to engage the track (17) for braking purposes when the user (not shown) squeezes the hand held brake levers (24) attached to the brake pads via cable (25) and brake biasing assembly (26). In a preferred embodiment, the brakes are configured with an inbuilt safety feature, whereby if the brake handles are fully released, an emergency brake pad (27) is automatically biased into contact with the track (17), thus preventing the board assembly (1) from uncontrolled movement if the user has become dislodged. In use the user may apply a braking force by squeezing the brake handle (24) which progressively engages the primary brake pad (23) in contact with the track surface (17) to slow the motion of the activity board (1).

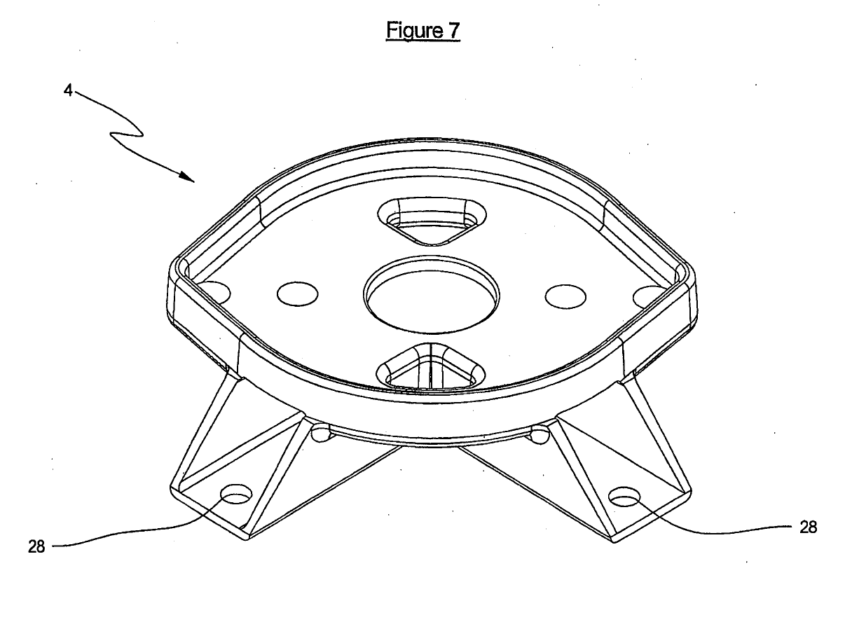

In an alternative embodiment, the base portion (4) may be adapted for securement directly to the ground via bolts, or even being permanently fixed in to a concrete foundation or the like. FIG. 7 shows a base portion (4) with the coil spring (5) and board assembly removed for clarity. The base portion (4) shown in FIG. 6 is provided with a ground engaging structure with apertures (28) for securing the bolts (not shown) or the like.

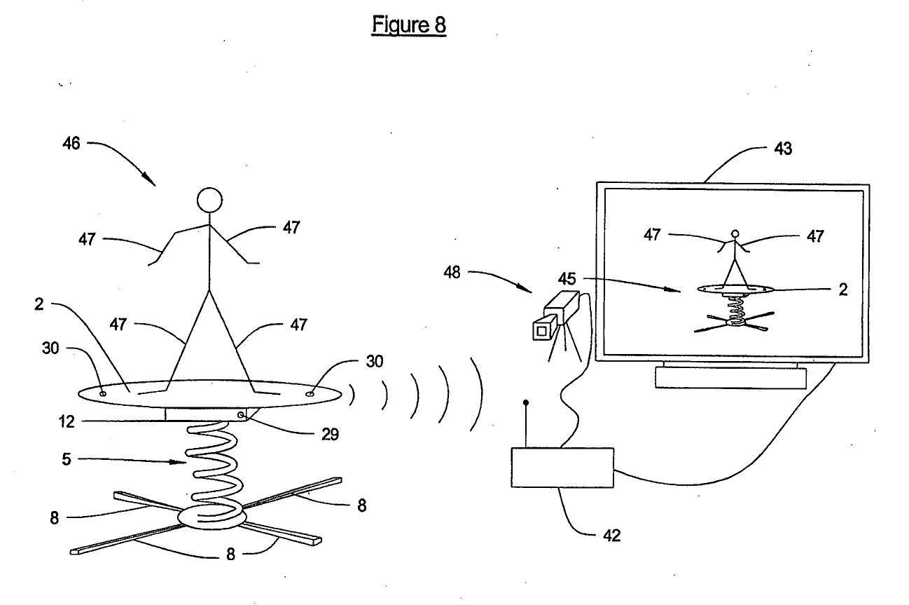

FIG. 8 shows a semantic representation of a further embodiment in which the activity board (1) is interfaced with a processor (42) and display means (43). As also shown more clearly in FIG. 2, a rotational movement sensor (29) and a position sensor (30) are respectively located adjacent the rotatable coupling (12) on the underside of the board (2) along the longitudinal axis “X” towards a distal end. The sensor (30) may operate with a variety of operating principles capable of determining the position of the sensor (30) from a fixed reference point such as the base portion (4) or the like.

Alternatively, the reference point may be located extending to the board at a known position in the area surrounding the board (1). In a preferred embodiment, the orientation and movement of the board (1) captured by the sensors (29, 30) is transmitted to the processor (42) by known wireless transmission means (44), although a physical cable may be employed as an alternative. The movement of the board (1) is calculated by the processor from the data received from the orientation and movement sensors. The processor then generates a corresponding depiction (45) of the user (46) and board (2) position which is represented on the display (43) to provide the user (46) with an on-screen simulation of their movements. This may be used as part of an interactive computer simulation and or training aid to hone the user's board riding skills.

In further embodiments the physical position of the users limbs (47) may also be detected and represented on the on-screen display. This may be achieved by capturing opto-electrical images of the user through digital video cameras (48) interfaced with the processor (42) and/or through sensors (not shown) placed on the users limbs which detect their relative orientation and movement according to a comparable technology to those used on the board (1)

Aspects of the present invention have been described by way of example only and it should be appreciated that modifications and additions may be made thereto without departing from the scope thereof.

1. An activity board assembly including;
a board having an upper surface for supporting a user,
a base portion and
a resilient support member having an upper and a lower distal end, said upper end being connected to an underside of said board and said lower distal end being connected to said base portion,
characterised in that the board is rotatable with respect to the base portion about;
a first axis in a plane substantially orthogonal with the upper surface of the board and/or the base portion;
a second axis substantially orthogonal to said first axis and substantially parallel to the upper surface of the board and/or the base portion;
a third axis orthogonal to both the first and second axis;
said connection between the resilient support member and the base portion being configured to prevent linear movement with respect to each other.

2. An activity board assembly as claimed in claim 1, wherein the board is rotatable about said first axis by a rotatable connection between the resilient support member and either the board or the base portion.

3-5. (canceled)

6. An activity board assembly as claimed in claim 1, wherein lateral displacement of said upper end of the support member from said first axis provides at least a component of rotational movement about the second or third axes.

7. An activity board assembly as claimed in claim 1, wherein the resilient support member is formed from at least one of: a coil spring: a unitary or laminate elastic rod; or any other object capable of bearing the weight of a user mounted on the board without permanent deformation whilst also being capable of resilient lateral displacement or bending at the upper end under the effects of eccentric forces applied by the user about the first axis.

8. An activity board assembly as claimed in claim 1, wherein the resilient support member is biased to return the board from a displaced position to an equilibrium position with the said first axis vertically aligned.

9. An activity board assembly as claimed in claim 1, wherein the resilient support member is adapted to allow linear movement of the board along said first axis.

10. An activity board assembly as claimed in claim 1, further including a tilting mechanism interposed between the upper end of the resilient support member and the lower surface of the board, capable of providing rotation about the second axis.

11-20. (canceled)

21. An activity board assembly as claimed in claim 1, wherein the base portion has a laterally-enlarged ground-engaging lower surface and a central connecting member connected to the lower end of the resilient support member.

22. An activity board assembly as claimed in claim 21, further incorporating at least one wheel or roller assembly located on said base portion ground-engaging lower surface.

23-30. (canceled)

31. An activity board assembly including;
a board having an upper surface for supporting a user,
a base portion and
a support member having an upper and a lower distal end, said upper end being connected to an underside of said board and said lower distal end being connected to said base portion,
characterised in that the board is rotatable with respect to the base portion about;
a first axis in a plane substantially orthogonal with the upper surface of the board and/or the base portion;
a second axis substantially orthogonal to said first axis and substantially parallel to the upper surface of the board and/or the base portion;
a third axis orthogonal to both the first and second axis;
said base portion being provided with one or more wheel or roller assemblies on a lower surface.

32-35. (canceled)

36. An activity board assembly as claimed in claim 1, further including at least one displacement assembly, located between said lower board surface and the resilient support member, said displacement assembly being configured to allow at least partially translational relative movement between the board and the resilient support member at least partially along, or parallel to the second and/or third axis.

37. An activity board assembly as claimed in claim 36, wherein said translational movement is constrained solely within a plane extending through both the first and third axes.

38. An activity board assembly as claimed in claim 37, wherein said translational movement is constrained to movement substantially along the third axis.

39-42. (canceled)

43. An activity board assembly including;
a board having an upper surface for supporting a user, a base portion;
a resilient support member having an upper and a lower distal end, said upper end being connected to an underside of said board and said lower distal end being connected to said base portion, and
at least one displacement assembly, located between said lower board surface and the resilient support member,
characterised in that the board is rotatable with respect to the base portion about;
a first axis in a plane substantially orthogonal with the upper surface of the board and/or the base portion;
a second axis substantially orthogonal to said first axis and substantially parallel to the upper surface of the board and/or the base portion;
a third axis orthogonal to both the first and second axis;
said displacement assembly being configured to allow at least partially translational relative movement between the board and the resilient support member at least partially along, or parallel to the second and/or third axis.

44-45. (canceled)

46. An activity board assembly including;
a board having an upper surface for supporting a user,
a base portion, and
a support member having an upper and a lower distal ends, said upper end being connected to an underside of said board and said lower distal end being connected to said base portion,
characterised in that the board is rotatable with respect to the base portion about;
a first axis in a plane substantially orthogonal with the upper surface of the board and/or the base portion;
a second axis substantially orthogonal to said first axis and substantially parallel to upper surface of the board and/or the base portion;
a third axis orthogonal to both the first and second axis;
said base portion being adapted for constrained movement along an elongate guiding track.

47-48. (canceled)

49. An activity board assembly as claimed in claim 46, further provided with a brake mechanism for controlling the speed of the activity board assembly along said elongated guiding track.

50-53. (canceled)

54. An activity board system including an elongated guiding track and one or more activity board assemblies as claimed in claim 49, said activity board assemblies being adapted for constrained movement along said elongated guiding track.

55-56. (canceled)

57. An activity board assembly as claimed in claim 1, adapted to interface with a processor and a display.

58. An activity board system including an activity board assembly as claimed in claim 57 including a processor configured to be interfaced with a display.

59. An activity board system as claimed in claim 58, further including a sensor system capable of detecting the position and/or movement of the board and transmitting same to said processor and display.

60-63. (canceled)

64. An activity board system as claimed in claim 59, wherein said sensor system includes a combination of location sensors and movement sensors, configured such that feedback from the sensors is input to said processor and thereafter output to said display as a graphical representation of the board's position and movement.

65-72. (canceled)
